(19) United States
(12) Patent Application Publication
(10) Pub. No.: US 2002/0189461 A1
(43) Pub. Date: Dec. 19, 2002

(54) Filter-paper insert for producing aroma extracts from ground coffee

(76) Inventor: Rainer Dolfel, Porta Westfalica (DE)

Correspondence Address: VENABLE, P.O. Box 34385, Washington, DC, 20043-9998, US

(21) Appl. No.: 10/084,661

(22) Filed: Feb. 28, 2002

(30) Foreign Application Priority Data
Mar. 3, 2001 (DE) DE 201 03 730.0

(51) Int. Cl. A47J 31/00

(52) U.S. Cl. 99/279

(57) ABSTRACT

A filter-paper insert, for producing aroma extracts from ground coffee, in the form of a frustoconical filter, a conical filter, a pyramidal filter, a basket filter or the like. The permeability of the filter paper from which the filter-paper insert (10) is produced is increased through perforations, imprinting or imprinted perforations (11), or a combination of these measures.

The present invention relates to a filter-paper insert for producing aroma extracts from ground coffee, in the form of a frustoconical filter, a conical filter, a pyramidal filter, a basket filter or the like.

Filter-paper inserts of the generic type are known in numerous embodiments. For producing aroma extracts from ground coffee, they are inserted into a filter housing; the housing is then filled with ground coffee and heated water is introduced into the filter housing, with the filter-paper insert and the ground coffee located therein, for producing filtered coffee.

In selecting the properties of such filter-paper inserts, it must be ensured that the brewing-water level does not exceed the upper edge of the filter-paper insert itself (in frustoconical filter-paper inserts or so-called basket filters) or the upper edge of the filter housing (in the use of circular filter sheets).

To this point, the risk of an overflow under certain conditions could never be completely ruled out with conventional filter-paper inserts.

It has been seen that the risk of overflow is particularly high with the use of decaffeinated coffee, or very finely-ground coffee, or when a relatively small filter is used to make a large number of cups of filtered coffee, or when soft water is used as the brewing water.

The risk of overflow increases if several of the aforementioned conditions are present simultaneously.

Aside from the risk of overflow, the aforementioned conditions stipulate a relatively long contact time between the brewing water and the aroma carrier (ground coffee), resulting in the production of fairly strong coffee.

It is the object of the present invention to create a filter-paper insert of the generic type, which significantly reduces the risk of overflow in comparison to known paper-filter inserts, and is particularly well-suited for producing a milder coffee or a less-strong coffee.

In accordance with the invention, the object is accomplished in that the permeability of the filter paper from which the filter-paper insert is produced is increased through perforation, imprinting or imprinted perforation, or a combination of these measures.

The increased permeability of the filter paper reduces the risk of an overflow when coffee is brewed. The filtration time of the filter-paper insert can be greatly reduced by the measures of the invention without significantly decreasing the stability of the paper, so a wet filter-paper insert according to the invention can be removed, with the used coffee grounds, from a filter housing without the risk of falling apart.

A filter-paper insert in accordance with the invention can advantageously be produced from a filter paper that has a filtration time of <30 seconds, as determined with the Herzberg method. The filtration time has been reduced to a value of less than 20 seconds through perforation, imprinting or imprinted perforation.

In the aforementioned Herzberg method, for measuring the filtering speed and wetness stability of filter papers, a filter paper sample having a testing surface area of 10 cm² is clamped into a testing cylinder, and water is poured onto it at a set pressure. A test pressure is set for testing the filtering speed of a 50-mm column of water, and the test is performed at a water temperature of 20° C.±1° C. The water must possess a hardness of 2-10° dH.

The water flowing through the filter paper under the above-described external test conditions flows via a discharge conduit into a measurement cylinder having a scale graduation of <2 ml. The filtering time is measured with a stopwatch having a scale graduation of <0.2 seconds.

Under the above-described test conditions, in addition to the filtering time, which is determined with a stopwatch, the filtering speed can also be determined, namely as the quotient of the filtering time and the filtered volume collected in the measurement cylinder.

The entire surface of the filter-paper insert can be provided with a perforation, imprinting, imprinted perforation or a combination of these perforations or material weakening measures, which increases its permeability.

The perforations and/or material weakening regions can be provided in the lower region of a frustoconical filter-paper insert.

It is also possible to distribute the perforations and/or material weakening regions in zones over the entire surface of a frustoconical filter-paper insert.

The attached drawings illustrate exemplary embodiments of the invention; they are described in detail below.

Shown are in:

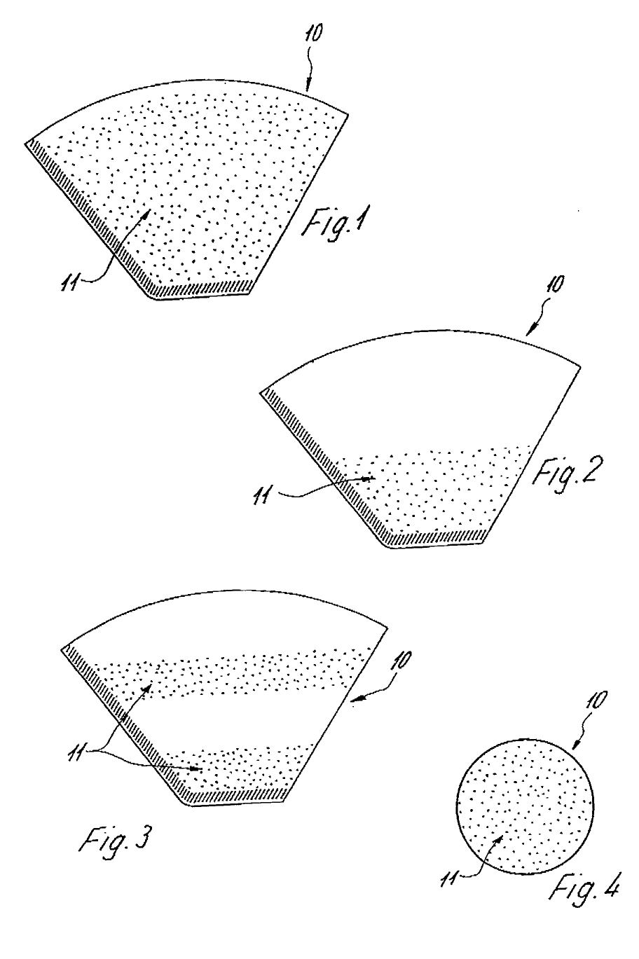

FIG. 1 a frustoconical filter-paper insert according to the present invention, having perforations or material weakening regions over its entire surface;

FIG. 2 a frustoconical filter-paper insert having perforations and/or material weakening regions in the lower region;

FIG. 3 a frustoconical filter-paper insert having perforations and/or material weakening regions in zones; and

FIG. 4 a circular filter sheet having perforations and/or material weakening regions over its entire surface.

FIG. 1 illustrates a filter-paper insert 10 in accordance with the invention, which is produced from a filter paper having a filtration time of about 30 seconds, as determined with the Herzberg method. In addition, the filter paper from which the filter-paper insert 10 is produced has been made more permeable through perforation, imprinting or an imprinted perforation 11, or a combination of these measures. The filtration time is preferably in a range of 15 to 20 seconds, as determined with the Herzberg method, following the provision of the perforations, imprinting or imprinted perforations 11.

With perforations or imprinted perforations, the used filter paper is perforated to a minimal extent. If only imprinting is used to increase the permeability, the filter paper can be weakened in the imprinted region to the point that the desired effect is attained.

The exemplary embodiment shown in FIG. 2 also involves a frustoconical filter-paper insert, which is, again, produced from a filter paper having a filtration time of about 30 seconds, as determined with the Herzberg method, and is only provided in its lower region with a perforation, imprinting or an imprinted perforation 11, or a combination of these measures.

In a modification, a perforation, imprinting or imprinted perforation 11 can also be provided solely in the upper region of the filter-paper insert 10.

As shown in FIG. 3, a frustoconical filter-paper insert 10 produced from a filter paper having the aforementioned properties can also be provided in zones with perforations, imprinting, imprinted perforations or a combination of these measures. Here, the arrangement, number and geometrical relationships of these zones can, of course, differ from the illustrated embodiment according to FIG. 3.

Finally, FIG. 4 illustrates a filter-paper insert 10 in the form of a circular filter sheet, which comprises a filter paper having a filtration time of about 30 seconds, as determined with the Herzberg method. The circular filter sheet is provided over its entire surface with perforations, imprinting or imprinted perforations 11, or a combination of these perforations and/or material weakening regions. In this case as well, these perforations and/or material weakening regions increase the permeability of the circular filter sheet.

All of these measures reduce the mechanical stress capacity of the respective filter-paper insert 10 only slightly or not at all, so in practice, all of the filter-paper inserts 10 are free of drawbacks.

In laboratory testing, conventional long-fiber sulfate pulps are used to produce a filter paper whose filtration time is less than 30 seconds, as determined with the Herzberg method, and whose surface weight is 54 g per qm. When dry, this filter paper has a breaking force of 21 Newtons in the longitudinal direction, and a breaking force of 19 Newtons in the transverse direction. The breaking force in the transverse direction was determined to be 3.5 Newtons when the paper was wet.

This paper filter was perforated with a porcupine roller, which resulted in a filtration time of 18 seconds, as determined with the Herzberg method. It was ascertained that the values for the breaking force were only insignificantly reduced; namely, they were 19.5 Newtons in the longitudinal direction, 15.5 Newtons in the transverse direction and 3.0 Newtons in the transverse direction when the paper was wet.

Despite these results, the brewing time was reduced considerably under different brewing conditions, such as different types of coffees, different degrees of grinding and different quantities of the used ground coffee.

1. A filter-paper insert for producing aroma extracts from ground coffee, in the form of a frustoconical filter, a conical filter, a pyramidal filter, a basket filter or the like, characterized in that the permeability of the filter paper from which the filter-paper insert (10) is produced is increased through perforations, imprinting or imprinted perforations (11), or a combination of these measures.

2. The filter-paper insert according to claim 1, characterized in that the filtration time of the filter paper from which the filter-paper insert is produced is reduced overall to a value of less than 20 seconds following the provision of a perforation, imprinting or an imprinted perforation, or a combination of these measures.

3. The filter-paper insert according to claim 1 or 2, characterized by the use of a filter paper whose filtration time prior to perforating, imprinting or imprinted perforating is about 30 seconds, as determined with the Herzberg method.

4. The filter-paper insert according to one of the foregoing claims, characterized in that the entire surface of the filter-paper insert (10) is provided with a perforation, imprinting, an imprinted perforation (11) or a combination of these perforations or material weakening regions, which increases its permeability.

5. The filter-paper insert according to one of the foregoing claims, characterized in that the perforations and/or material weakening regions produced through perforation, imprinting or imprinted perforation are provided in the lower region in a frustoconical filter-paper insert.

6. The filter-paper insert according to one of the foregoing claims, characterized in that the perforations and/or material weakening regions produced through perforation, imprinting or imprinted perforation (11) or a combination of these measures are provided in the upper region in a frustoconical filter-paper insert.

7. The filter-paper insert according to one of the foregoing claims, characterized in that the perforations and/or material weakening regions produced through perforation, imprinting or imprinted perforation are distributed in zones over the entire surface of a frustoconical filter-paper insert (10).
